(19) United States
(12) Patent Application Publication
(10) Pub. No.: US 2005/0028628 A1
(43) Pub. Date: Feb. 10, 2005

(54) Non-contact type wheel transmission structure

(76) Inventor: Yung-Ho Liue, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/883,659

(22) Filed: Jul. 6, 2004

(30) Foreign Application Priority Data
Aug. 8, 2003 (TW) 92121805

(51) Int. Cl. F16H 35/00

(52) U.S. Cl. 74/431; 74/DIG. 4

(57) ABSTRACT

A non-contact type wheel transmission structure is disclosed to include two transmission wheels set in proximity to each other without contact, each transmission wheel having grooves equiangularly spaced around the periphery and magnets respectively fixedly mounted in the grooves, the magnets of one of transmission wheel being reversed in polarity to the magnets of the other transmission wheel for causing magnetic attraction between the transmission wheels.

### BACKGROUND OF THE INVENTION

1. Field of the Invention

The present invention relates to a wheel transmission structure and more particularly, to a non-contact type wheel transmission structure, which uses magnetic attraction to drive the second wheel to rotate when the first wheel that is set in proximity to the second wheel without contact is rotated.

2. Description of the Related Art

The invention of gear transmission greatly enhances development of all kinds of industries. Gear transmission is intensively used in precision mechanical mechanisms as well as heavy-duty machines. A gear transmission mechanism, as shown in FIGS. 8 and 9 uses two meshed gears 4 for transmission of rotary driving force. As illustrated, the gears 4 each have teeth 41 and pits 42 alternatively arranged around the periphery. The fabrication of the gears 4 is complicated. In addition to critical precision requirement, selection of wear-resisting material for the gears 4 during fabrication is also important. Due to these reasons, the manufacturing cost of the gears 4 is high. Further, because the transmission between the gears 4 is a contact type transmission, friction and noises are produced during a high-speed rotation. Therefore, a conventional gear transmission structure is not suitable for use in a clean room, inflammable product fabrication plant, or any place where the temperature must be kept within a limited range.

Further, when a split type air-conditioner is used, the compressor and the radiator are set outdoors, however, the indoor unit still needs a motor to rotate the fan blade. The fan motor produces heat a certain amount of time during operation, thereby lowering the cooling efficiency of the air-conditioner.

### SUMMARY OF THE INVENTION

The present invention has been accomplished under the circumstances in view. It is the main object of the present invention to provide a non-contact type wheel transmission structure, which causes little noise and heat. It is another object of the present invention to provide a non-contact type wheel transmission structure, which saves much energy. It is still another object of the present invention to provide a non-contact type wheel transmission structure, which is durable in use. It is another object of the present invention to provide a non-contact type wheel transmission structure, which uses magnetic attraction to drive a second transmission wheel to rotate upon rotation of a first transmission wheel that is set in proximity to the second transmission wheel without contact. To achieve these and other objects of the present invention, the non-contact type wheel transmission structure comprises two transmission wheels set in proximity to each other without contact. Each transmission wheel comprises a plurality of grooves equiangularly spaced around the periphery, and a plurality of magnets respectively fixedly mounted in the grooves. The magnets of one transmission wheel are reversed in polarity to the magnets of the other transmission wheel for causing magnetic attraction between the transmission wheels.

### BRIEF DESCRIPTION OF THE DRAWINGS

FIG. 1 is an exploded view of a non-contact type wheel transmission structure according to the first embodiment of the present invention.

FIG. 2 is a perspective view showing a glass plate set between the two transmission wheels of the non-contact type wheel transmission structure-according to the first embodiment of the present invention.

FIG. 3 is a sectional end view of FIG. 2.

FIG. 4 is a sectional view showing a layer of protective coating covered on the transmission wheel according to the first embodiment of the present invention.

FIG. 5 is an exploded view of a non-contact type wheel transmission structure according to the second embodiment of the present invention.

FIG. 6 is a sectional view showing a glass plate set between the two transmission wheels of the non-contact type wheel transmission structure according to the second embodiment of the present invention.

FIG. 7 is an end view of one transmission wheel according to the second embodiment of the present invention.

FIG. 8 is a perspective view of a gear transmission structure according to the prior art.

FIG. 9 is a sectional end view of gear transmission structure according to the prior art.

### DETAILED DESCRIPTION OF THE PREFERRED EMBODIMENT

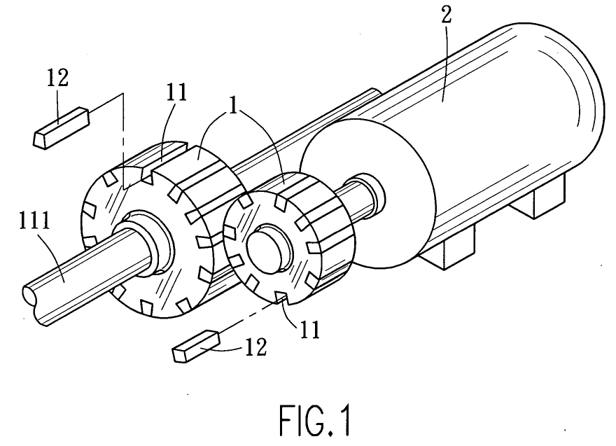

Referring to FIG. 1, a non-contact type wheel transmission structure in accordance with the present invention is shown comprising two transmission wheels 1 respectively fixedly mounted on, for example, the output shaft of a motor 2 and a transmission shaft 111. Each transmission wheel 1 comprises a plurality of grooves 11 equiangularly spaced around the periphery, and a plurality of magnets 12 respectively fixedly mounted in the grooves 11.

Referring to FIG. 1 again, the magnets 12 of the two transmission wheels 1 are reversed in polarity and the two transmission wheels 1 are set in proximity to each other without contact. When starting the motor 2 to rotate the respective transmission wheel 1, the other transmission is caused to rotate by magnetic attraction, and therefore the transmission shaft 111 is rotated. Because of non-contact transmission, rotation of the transmission wheels 1 does not cause noise or produce heat. Therefore, this design of non-contact type wheel transmission structure is practical for use in a clean room, inflammable product fabrication plant, or any place where the temperature must be kept within a limited range.

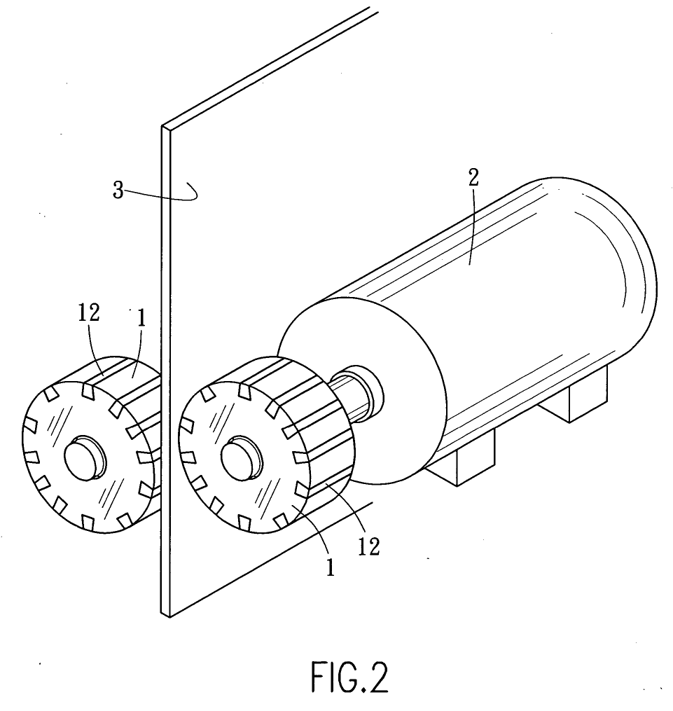

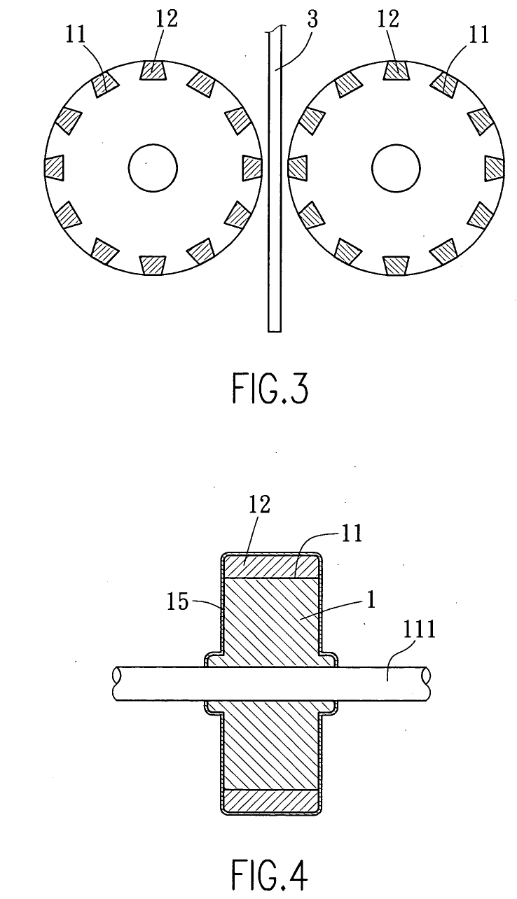

Referring to FIGS. 2 and 3, the two transmission wheels 1 can be set at two sides of a partition plate 3 that is not magnetically conductive, for example, glass plate.

Referring to FIG. 4, each transmission wheel 1 may be covered with a layer of protective coating 15 that protects the magnets 12 against dust and moisture.

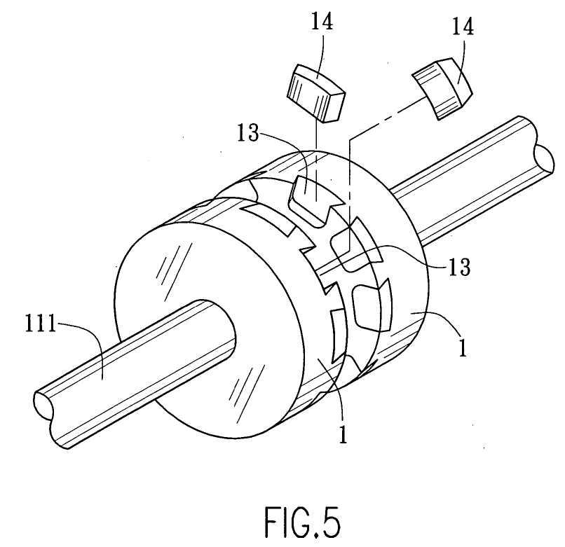

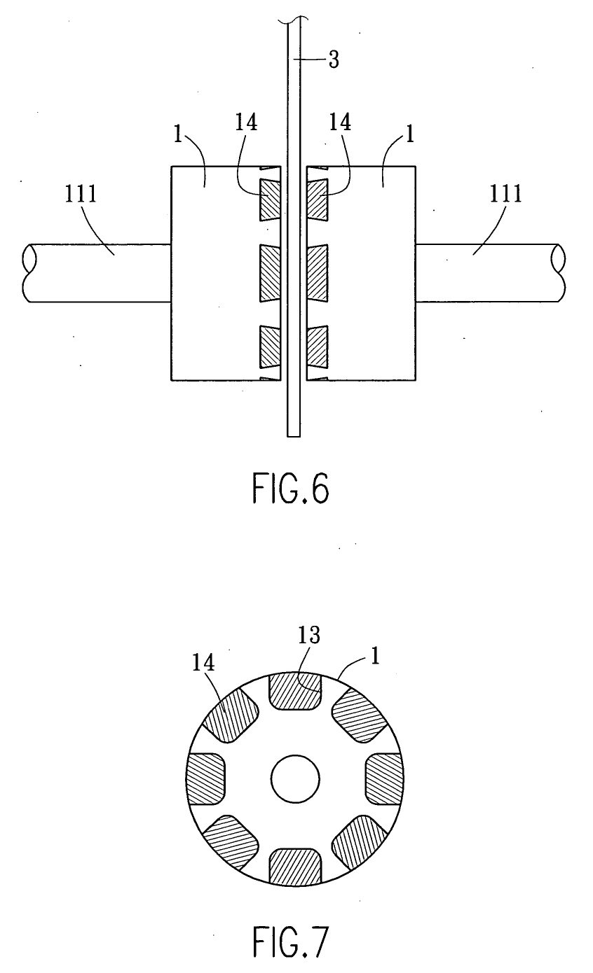

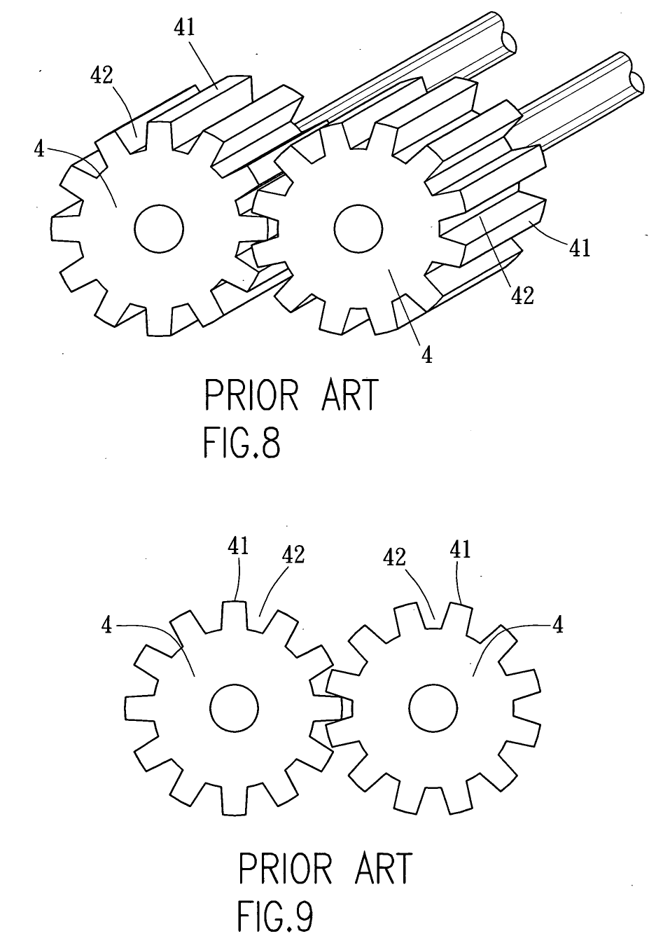

FIGS. 5˜7 show an alternate form of the present invention. According to this embodiment, each transmission wheel 1 comprises a plurality of grooves 13 formed in one side and equiangularly spaced around the border area, and a plurality of magnets 14 respectively fixedly mounted in the grooves 13. The two transmission wheels 1 are set in proximity to each other without contact and axially aligned, keeping the respective magnet-provided sides facing each other. When rotating one of the transmission wheels 1, the other of the transmission wheels 1 is caused to rotate by magnetic attraction. Further, a partition plate 3 that is not magnetically conductive may be set between the transmission wheels 1 as shown in FIG. 6.

Further, the aforesaid grooves 11, 13 and magnets 12, 14 are preferably made having a trapezoidal cross section. Glue may be used to bond the magnets 12, 14 to the grooves 11, 13.

1. A non-contact type wheel transmission structure comprising two transmission wheels set in proximity to each other without contact, said transmission wheels each comprising a plurality of grooves equiangularly spaced around the periphery thereof, and a plurality of magnets respectively fixedly mounted in said grooves, the magnets of one of said transmission wheels being reversed in polarity to the magnets of the other of said transmission wheels for causing magnetic attraction between said transmission wheels.

2. The non-contact type wheel transmission structure as claimed in claim 1, wherein each said transmission wheel further comprising a protect coating covered on the periphery thereof over the respective magnets to protect the respective magnets against dust and moisture.

3. The non-contact type wheel transmission structure as claimed in claim 1, wherein the grooves and magnets of said transmission wheels have a trapezoidal cross section.

4. A non-contact type wheel transmission structure comprising two transmission wheels set in proximity to each other without contact, said transmission wheels each comprising a plurality of grooves formed in one side thereof and equiangularly spaced around the border of the respective side, and a plurality of magnets respectively fixedly mounted in said grooves, the magnets of one of said transmission wheels being reversed in polarity to the magnets of the other of said transmission wheels for causing magnetic attraction between said transmission wheels.

5. The non-contact type wheel transmission structure as claimed in claim 4, wherein each said transmission wheel further comprising a protect coating covered on the periphery thereof over the respective magnets to protect the respective magnets against dust and moisture.

6. The non-contact type wheel transmission structure as claimed in claim 4, wherein the grooves and magnets of said transmission wheels have a trapezoidal cross section.
